(19) United States
(12) Patent Application Publication
(10) Pub. No.: US 2007/0204573 A1
(43) Pub. Date: Sep. 6, 2007

(54) Nestable, rigid filter frame

(76) Inventor: Thomas A. Justice, (US)

Correspondence Address: NIXON PEABODY, LLP, 401 9TH STREET, NW, SUITE 900, WASHINGTON, DC, 20004-2128, US

(21) Appl. No.: 11/367,710

(22) Filed: Mar. 6, 2006

(51) Int. Cl. B01D 46/00

(52) U.S. Cl. 55/495; 55/502

(57) ABSTRACT

A filter having a generally rectangular nestable frame member, said frame member includes an upper frame portion and a lower frame portion. Each frame portion comprises: a first leg; and a second leg extending obtusely from the first leg, with the obtuse angle between the first and second legs of the upper frame portion being smaller than the obtuse angle between the first and second legs of the lower frame portion. The first legs of the upper and lower frame portions are generally parallel to one another, and securely engaging the peripheral edges of the filter medium in-between. The opposing surfaces of the second leg of the upper frame portion and the second leg of the lower frame portion define a hollow space in-between. The filter medium material is attached to the frame, by adhesion clamping, or any other suitable engagement means.

### BACKGROUND OF THE INVENTION

1. Field of the Invention

The present invention relates generally to air filters and, more particularly, to a nestable frame for planar air filters or other screen-like planar structures.

2. Description of the Prior Art

Filters are typically provided in heating, ventilating and air conditioning equipment upstream of the air handler for removing particulate impurities from the air principally in order to protect the equipment, and secondarily to remove particulate impurities from the air circulated within homes, offices and industrial environments that affect the indoor air quality to which people are exposed. Such filters are also used for removing impurities entrained in air or another gas prior to release of the gas into the atmosphere. Various industrial processes also use filters for removing particulates from gases or other fluids.

Filters are typically formed by mounting a panel of a filter medium, such as a fibrous mat or porous foam or a pleated panel of a filter medium to reduce the relative pressure drop, within a surrounding support frame. The frame supports the filter medium in a relatively planar shape and provides mechanical strength for retaining the filter in a manner which is not only mechanically secure but also seals well to its associated machinery so that all of the fluid flow is directed through the filter medium.

It is desirable for a filter to be inexpensive and have sufficient strength and durability. It is also desirable to maximize the effective filtering area of a filter and to permit the compact packaging of multiple filters for efficient distribution and storage.

U.S. Pat. No. 3,970,440 shows filters having a frame comprising planar frame members engaging a substantially sheet-form filter element there-between, and having flared frame members disposed at an angle of less than 180.degree, with the portions of the flared frame members being connected together.

U.S. Pat. No. 4,636,233 shows a similar pinch frame construction. Because the frame material extends over the peripheral portion of both opposite, major faces of the uncompressed filter medium, the filter medium in this patent cannot be compressed without distorting and damaging the frame.

U.S. Pat. No. 6,033,454 shows a rectangular frame construction having rails flaring outboard at an obtuse angle from the filter plane, with one of the rails at each corner of the rectangular frame being provided with tabs, and the other, contiguous of the rails at the corner having an open end into which the tab extends.

However, none of the generally rectangular filter frame constructions described in the prior art provides a frame which permits nesting of a stack of such filters with significant space-savings during storage and transport, and which is also simple to handle and inexpensively provide a frame with enhanced rigidity.

Thus, there remains a need for a stackable filter frame that is cost-efficient in manufacture and operation, and simple in design, which can be compactly stacked during storage and transport while providing simplicity in its handling, and yet exhibits structural rigidity to provide a high-quality product.

### SUMMARY OF THE INVENTION

It is therefore an object of the present invention to provide a planar, generally rectangular, nestable air filter capable of providing a simple, stable frame for planar air filter panels.

It is an additional object of the present invention to provide a filter frame which is cost-effective in manufacturing and operation, and allows for savings in storage and transportation cost.

It is another object to provide an air filter which is easy to handle, and at the same time is sufficiently strong so that complex and unusual reinforcing means need not be used.

It is an additional object of the invention to provide an air filter frame which is simpler in assembly than that of air filter frames disclosed in the art.

Still other objects will readily present themselves to one skilled in the art upon reference to the following specification, the drawings, and the claims.

In a preferred embodiment of the present invention, the filter comprises a filter medium panel, and a generally rectangular frame member. The filter medium panel has peripheral edges and first and second opposite major faces. The frame member surrounds the peripheral edges of the filter medium panel. The frame member has a cross-section comprising an upper frame portion and a lower frame portion. Each frame portion comprises a first leg; and a second leg extending obtusely from the first leg, with the obtuse angle between the first and second legs of the upper frame portion being smaller than the obtuse angle between the first and second legs of the lower frame portion. The first legs of the upper and lower frame portions are generally parallel to one another, and securely engage the peripheral edges of the filter medium in-between them. The opposing surfaces of the second leg of the upper frame portion and the second leg of the lower frame portion define a hollow space in-between.

In a preferred embodiment, the first legs of the upper and lower frame portions are parallel to one another, with the peripheral edges of the filter medium completely filling the space confined between the opposing surfaces of the first legs of the upper and lower frame portions. In another preferred embodiment, the first legs of the upper and lower frame portions are parallel to one another, with the peripheral edges of the filter medium only partially filling the space confined between the opposing surfaces of the first legs of the upper and lower frame portions, with the remaining part of the space preferably, at least partially, filled with adhesive means.

In still another preferred embodiment, the relatively outer parts of the first legs of the upper and lower frame portions are parallel to one another, while the relatively inner parts of the first legs extend obtusely relative to one another, with the peripheral edges of the filter medium being engaged between the opposing surfaces of the relatively inner parts of the first legs of the upper and lower frame portions.

The peripheral edges of filter medium is securely engaged in-between the first legs of the upper and lower frame portions by adhesion, clamping, and/or any other suitable engagement means.

In a preferred embodiment, the frame member is made from one single piece of material, suitably folded back on itself at the outside edges of the frame member. In another preferred embodiment, the frame member is made from four pieces of material, each forming one side of the frame member, and each suitably folded back on itself at the outside edges of the frame member. In still another preferred embodiment, the frame member is made from a number of pieces of material, each forming either one side, or more than one side of the frame member, and each suitably folded back on itself at the outside edges of the frame member. Alternatively, the frame may be constructed from two die cut pieces, each having four sides; thus eliminating the need to fold the frame back on itself.

### BRIEF DESCRIPTION OF DRAWINGS

FIG. 1 is a perspective illustration of a planar air filter comprising the nestable frame in a preferred form of the present invention.

FIG. 2 is a view in a partial vertical section taken substantially along the line 2-2 of FIG. 1, illustrating a segment of the filter of FIG. 1.

FIG. 3 is a view in a partial section similar to the section of FIG. 2, but illustrating an alternative embodiment of the invention.

FIG. 4 is a view in a partial section similar to the section of FIG. 2, but illustrating another alternative embodiment of the invention.

FIG. 5 is a view in section similar to the section of FIG. 2, but illustrating a plurality of stacked filters in a package.

### DETAILED DESCRIPTION OF THE PREFERRED EMBODIMENTS

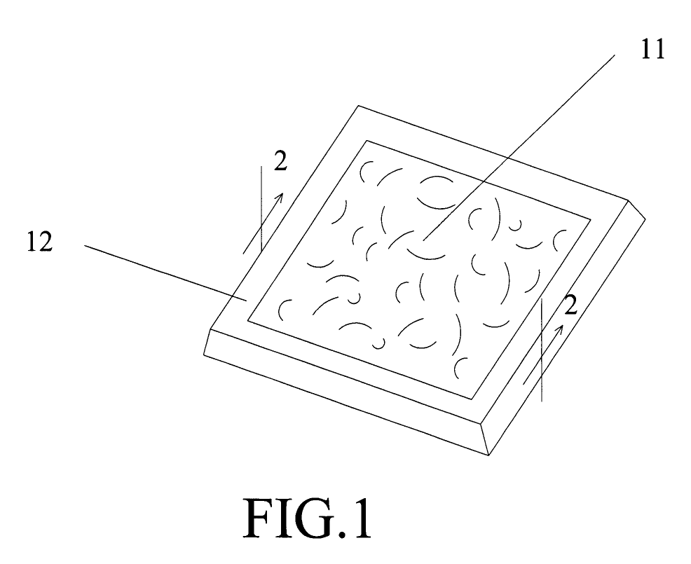

In the following description, it is to be understood that such terms as “upper”, “lower”, “inner”, “outer”, and the like are words of convenience and are not to be construed as limiting terms. Also, in FIGS. 1 through 5, reference numeral (11) indicates the filter medium panel mounted in the generally rectangular filter frame member, and reference numeral (12) indicates the frame member. Preferably, the frame member may be made of cardboard. Alternatively, the frame member could be made of thermoformed polystyrene, PVC, paperboard, or similar materials.

FIG. 1 is a perspective illustration of a planar air filter comprising the nestable frame in a first preferred form of the invention.

Preferably, the filter comprises a filter medium panel (11), and a generally rectangular or square frame member (12). The frame member (12) surrounds the peripheral edges of the filter medium panel (11). Alternatively, the frame member may be, triangular, or polygonal in shape (having multiple edges). The frame member edges preferably are equivalent in length; however, alternatively the frame member edges may be of varying lengths, allowing a frame to be designed to fit in any shape needed. For instance, the frame may be trapezoidal in shape.

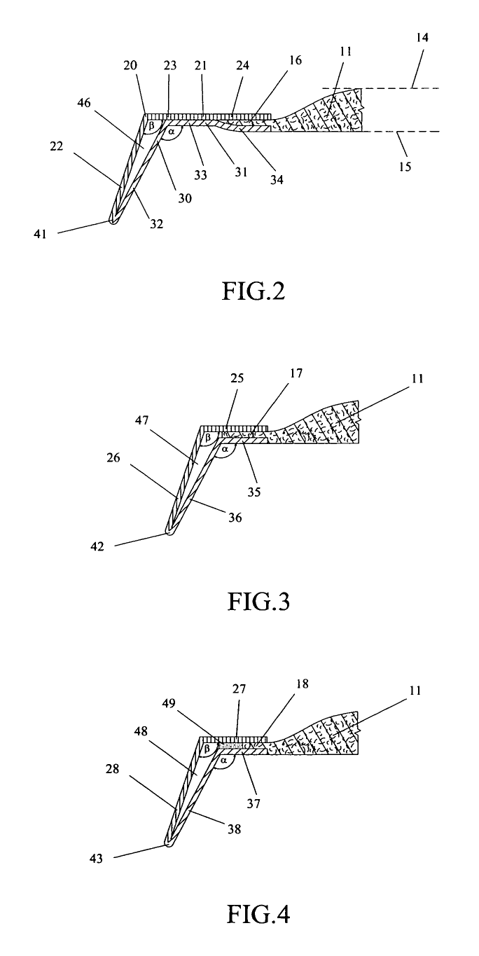

And as also shown in FIG.2, which is a view in a partial vertical section taken substantially along the line 2-2 of FIG. 1, illustrating a segment of the filter of FIG. 1, the filter medium panel (11) has a first (14) and a second (15) opposing major surfaces. Alternatively, the filter medium panel may be pleated.

The frame member comprises an upper frame portion (20) and a lower frame portion (30). Each frame portion comprises a first leg (21,31); and a second leg (22,32) extending obtusely from the first leg, with the obtuse angle (β) between the first and second legs (21,22) of the upper frame portion being smaller than the obtuse angle (α) between the first and second legs (31,32) of the lower frame portion. The opposing surfaces of the second leg of the upper frame portion (22) and the second leg of the lower frame portion (32) define a hollow space (46) in-between. The hollow space provides for enhanced rigidity of the fame member by increasing the frame member's cross-sectional second moment of inertia (about an axis that is perpendicular to the page on which FIG. 2 is printed).

The relatively outer parts of the first legs of the upper and lower frame portions (23, 33) are parallel to one another, while the relatively inner parts of the first legs (24, 34) extend obtusely relative to one another, with the peripheral edges of the filter medium panel (16) being engaged between the opposing surfaces of the relatively inner parts (24, 34) of the first legs of the upper and lower frame portions.

The peripheral edges of filter medium (16) are securely engaged in-between the first legs (24, 34) of the upper and lower frame portions by adhesion, clamping, and/or any other suitable engagement means.

The frame member is either made from one single piece of material, suitably folded back on itself (41) at the outside edges of the frame member, or the frame member is made from four pieces of material, each forming one side of the frame member, and each suitably folded back on itself (41) at the outside edges of the frame member, or the frame member is made from a number of pieces of material, each forming either one side, or more than one side of the frame member, and each suitably folded back on itself (41) at the outside edges of the frame member. Outermost point 41 shows how the frame member's cross section is preferably a unitary, integral, continuous piece of contiguous material conterminously connected at the outermost point 41. Alternatively, the frame may be constructed from two die cut pieces, each having four sides; thus eliminating the need to fold the frame back on itself. In this last embodiment, the connection between the upper and lower portions of the frame member at the outermost point 41 is eliminated.

FIG. 3 is a view in a partial section similar to the section of FIG. 2, but illustrating an alternative embodiment of the invention.

In this embodiment, the frame member comprises an upper frame portion and a lower frame portion. Each frame portion comprises a first leg (25,35); and a second leg (26,36) extending obtusely from the first leg, with the obtuse angle (β) between the first and second legs (25,26) of the upper frame portion being smaller than the obtuse angle (α) between the first and second legs (35,36) of the lower frame portion. The opposing surfaces of the second leg of the upper frame portion (26) and the second leg of the lower frame portion (36) define a hollow space (47) in-between. The hollow space provides for enhanced rigidity of the fame member by increasing the frame member's cross-sectional second moment of inertia (about an axis that is perpendicular to the page on which FIG. 3 is printed).

The first legs (25,35) of the upper and lower frame portions are parallel to one another, with the peripheral edges of the filter medium (17) completely filling the space confined between the opposing surfaces of the first legs (25,35) of the upper and lower frame portions.

The peripheral edges of filter medium (17) are securely engaged in-between the first legs (25, 35) of the upper and lower frame portions by adhesion, clamping, and/or any other suitable engagement means.

The frame member is either made from one single piece of material, suitably folded back on itself (42) at the outside edges of the frame member, or the frame member is made from four pieces of material, each forming one side of the frame member, and each suitably folded back on itself (42) at the outside edges of the frame member, or the frame member is made from a number of pieces of material, each forming either one side, or more than one side of the frame member, and each suitably folded back on itself (42) at the outside edges of the frame member. Outermost point 42 shows how the frame member's cross section is preferably a unitary, integral, continuous piece of contiguous material conterminously connected at the outermost point 42. Alternatively, the frame may be constructed from two die cut pieces, each having four sides; thus eliminating the need to fold the frame back on itself. In this last embodiment, the connection between the upper and lower portions of the frame member at the outermost point 42 is eliminated.

FIG. 4 is a view in a partial section similar to the section of FIG. 2, but illustrating another alternative embodiment of the invention.

In this embodiment, the frame member comprises an upper frame portion and a lower frame portion. Each frame portion comprises a first leg (27,37); and a second leg (28,38) extending obtusely from the first leg, with the obtuse angle (β) between the first and second legs (27,28) of the upper frame portion being smaller than the obtuse angle (α) between the first and second legs (37,38) of the lower frame portion. The opposing surfaces of the second leg of the upper frame portion (28) and the second leg of the lower frame portion (38) define a hollow space (48) in-between. The hollow space provides for enhanced rigidity of the fame member by increasing the frame member's cross-sectional second moment of inertia (about an axis that is perpendicular to the page on which FIG. 4 is printed).

The first legs (27, 37) of the upper and lower frame portions are parallel to one another, with the peripheral edges of the filter medium (18) partially filling the space confined between the opposing surfaces of the first legs (27, 37) of the upper and lower frame portions, with the remaining part of the space filled with adhesive means (49).

The peripheral edges of filter medium (18) are securely engaged in-between the first legs (27, 37) of the upper and lower frame portions by the adhesive means (49), clamping, and/or any other suitable engagement means.

The frame member is either made from one single piece of material, suitably folded back on itself (43) at the outside edges of the frame member, or the frame member is made from four pieces of material, each forming one side of the frame member, and each suitably folded back on itself (43) at the outside edges of the frame member, or the frame member is made from a number of pieces of material, each forming either one side, or more than one side of the frame member, and each suitably folded back on itself (43) at the outside edges of the frame member. Outermost point 43 shows how the frame member's cross section is preferably a unitary, integral, continuous piece of contiguous material conterminously connected at the outermost point 43. Alternatively, the frame may be constructed from two die cut pieces, each having four sides; thus eliminating the need to fold the frame back on itself. In this last embodiment, the connection between the upper and lower portions of the frame member at the outermost point 43 is eliminated.

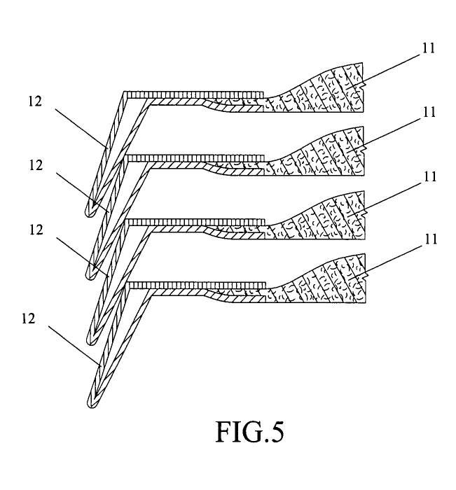

FIG. 5 shows by example of the frame design of FIG. 2, how multiple filter frame members (12) can be stacked normal to the filter medium panel (11) plane, further referred to as vertically, and nested in such a way that they take significantly less space vertically than the same number of filters would take if they were not nested, but stacked on top of each other.

Certain modifications and improvements will occur to those skilled in the art upon a reading of the detailed description. For example, the frame materialAll modifications and improvements have been deleted herein for the sake of conciseness and readability but are properly within the scope of the following claims.

What is claimed is:

1. A filter frame having a cross-section comprising:
a. an upper and a lower frame portion;
b. wherein the upper frame portion comprises a first leg and a second leg extending at a first obtuse angle from the first leg;
c. wherein the lower frame portion comprises a first leg and a second leg extending at a second obtuse angle from the first leg;
d. wherein the first legs of both the upper and lower frame portions are parallel to each other; and
e. wherein the second legs of upper and lower frame portions define a hollow space between the second legs.

2. The filter frame of claim 1, wherein the first obtuse angle is smaller than the second obtuse angle.

3. The filter frame of claim 1, wherein the upper and lower frame portions are made from more than one piece of material.

4. The filter frame of claim 3, wherein the second legs of both the upper and lower frame portions have an outermost point and the upper and lower frame portions are not conterminously connected at the outermost point.

5. The filter frame of claim 1, wherein the upper and lower frame portions are made from one contiguous piece of material.

6. The filter frame of claim 5, wherein the second legs of both the upper and lower frame portions have an outermost point and the upper and lower frame portions are conterminously connected at the outermost point.

7. A filter comprising:
a. a filter medium having at least one peripheral edge and first and second opposite major faces; and
b. a frame member surrounding the at least one peripheral edge of the filter medium panel, the frame member having a cross-section comprising:
i. an upper and a lower frame portion;
ii. wherein the upper frame portion comprises a first leg and a second leg extending at a first obtuse angle from the first leg;
iii. wherein the lower frame portion comprises a first leg and a second leg extending at a second obtuse angle from the first leg;
iv. wherein the first legs of both the upper and lower frame portions are parallel to each other; and
v. wherein the second legs of upper and lower frame portions define a hollow space between the second legs.

8. The filter of claim 7, wherein the first obtuse angle is smaller than the second obtuse angle.

9. The filter of claim 7, wherein the peripheral edges of the filter medium completely fills a space between the first legs of the upper and lower frame portions.

10. The filter of claim 7, wherein the peripheral edges of the filter medium partially fills a space between the first legs of the upper and lower frame portions.

11. The filter of claim 7, wherein the frame member is made from one contiguous piece of material.

12. The filter of claim 7, wherein the frame member is made from more than one piece of material.

13. The filter of claim 7, wherein the frame member is made from more than one contiguous piece of material.

14. The filter of claim 7, wherein the second legs of both the upper and lower frame portions have an outermost point and the upper and lower frame portions are conterminously connected at the outermost point.
